(19) United States
(12) Patent Application Publication
(10) Pub. No.: US 2006/0202434 A1
(43) Pub. Date: Sep. 14, 2006

(54) Cable sealing and/or feedthrough device

(76) Inventors: Jos Willems, Bertem (BE); Amandus Pieck, Kortenaken (BE); Els Timmermans, Wilsele (BE)

Correspondence Address: BAKER & DANIELS LLP, 300 NORTH MERIDIAN STREET, SUITE 2700, INDIANAPOLIS, IN, 46204, US

(21) Appl. No.: 10/545,744

(22) PCT Filed: Feb. 3, 2004
(86) PCT No.: PCT/GB04/00412

§ 371 Date: Aug. 16, 2005

(30) Foreign Application Priority Data
Feb. 19, 2003 (GB) 0303782.7

(51) Int. Cl. H02G 3/22

(52) U.S. Cl. 277/606

(57) ABSTRACT

Device for sealing an aperture, the device comprising liquid-in-polymer gel material (10) and means (11, 15) for forcing the gel material outwards into compression against an interior surface of the aperture in which the device is to be positioned in use, characterised in that a thin, flexible and preferably stretchable, coherent film (30, FIG. 4) of plastics material is positioned on (preferably adhered to) a surface of the gel material intended to seal against the said interior surface, preferably with a liquid component (30, FIG. 4) of the gel material in between the film and the interior surface.

The present invention relates to an article for forming a cable seal, in particular for forming a ready access butt closure or an in-line closure for a telecommunications or other cable splice. It may however be used for forming a cable feedthrough.

Cable splices have to be sealed against the environment to prevent damage to the cable conductors and connectors joining them. When a cable splice is made, cable jacket is stripped back from the ends of the cables to be spliced to expose the conductors to be connected. After the splice is made a so-called splice case, or splice closure, is built up around the splice. In the case of an in-line splice (made between ends of cables that face one another) two seals need to be made, one at each end of a generally cylindrical housing that surrounds the splice. For in-line splices, the housing is often of the wrap-around type, having an axial (longitudinal) opening with appropriate clamping closure means, as is well known.

In certain instances it is desirable for the splice to be of butt, rather than in-line configuration. This means that two or more cables lying side-by-side with their ends pointing in the same direction are spliced together. An advantage is that a housing comprising a domed cover can be slid over the resulting splice. A single seal then has to be made where the cables leave the open end of the housing. Also, the housing of a butt closure need not be of the wrap-around type and can still be removed.

WO-A-90/05401 (Raychem) discloses an in-line splice closure that can avoid the use of heat-shrinkable materials. A sealing material, for example a gel, is provided as part of end seals that seal gaps between in-going and out-going cables of a splice case, a central part of which comprises a generally cylindrical wrap-around housing. The end seals comprise the gel between structures that can be brought together to deform the gel to seal it to the cables and the central housing. WO-A-93/26069 (Raychem) discloses a butt splice enclosure with similar gel seal axially insertable into and removable from the open end of its domed housing.

Whilst satisfactory seals can be made using the closures described above, inserting or removing the sealing device into or from the housing may be difficult due to friction between the gel and the housing. This is especially likely after long-term adhesion of the gel sealant to the interior surface of the housing. This problem may be especially severe when the sealing device is axially inserted in and removed from the aperture(s) of the housing.

The present invention addresses this problem and accordingly provides a device for sealing an aperture, the device comprising liquid-in-polymer gel material and means for forcing the gel material outwards into compression against an interior surface of the aperture in which the device is to be positioned in use, characterised in that a thin, flexible and/or stretchable, coherent film of plastics material is positioned on (preferably adhered to) a surface of the gel material intended to seal against the said interior surface, preferably with a liquid component of the gel material in between the film and the interior surface.

It is preferred that the plastics film thickness is within the range from 10 to 50 micrometres, preferably 15 to 40 micrometres, more preferably 20 to 30 micrometres. It is also preferable that the plastics film is permeable to a liquid component of the gel material. In many cases, it may be desirable that the plastics film is polyethylene, preferably linear-low-density polyethylene similar or identical to food wrapping cling film, a useful example being Type 23MX Mobil (Trade Mark) cling film. The invention is especially useful for devices having the gel material sandwiched between relatively rigid members and having means for drawing the rigid members together axially so as to deform the gel laterally outwards. For sealing of cables into splice closures or wall feed-throughs, the device will have at least one axial through-hole through which cables or other elongate articles can extend.

The invention naturally includes the device positioned in and sealing an aperture in a wall or in the housing of a cable joint enclosure, and especially positioned in and sealing an aperture in a wall or in a housing of a cable joint enclosure about one or more cables or other elongate objects extending through the said through-hole(s) in the device. The invention is especially useful when the aperture it is sealing is an open end of a circumferentially continuous cable joint enclosure, preferably a butt joint domed enclosure, in which the sealing device is axially inserted or removed.

The invention also includes a kit-of-parts for enclosing a cable splice, comprising a device according to claim 6 and a housing capable of enclosing parts of one or more cables extending through the said device when the said device is positioned in and seals an aperture of the housing.

Another aspect of the invention provides a method of making a device according to the aforementioned aspects of the invention, comprising applying the said film of plastics material on the surface of the gel material and heating to bond the film to the gel material. Preferably, the said film is wrapped around the device in contact with the surface of the gel material, and the heating causes some circumferential shrinkage of the film. The plastics film may be oriented to some extent during its manufacture, perhaps preferably more uniaxially oriented than biaxially oriented, but orientation is not essential provided that suitably flexible and/or stretchable films, which prevent adhesion of the gel to the aperture surface while still achieving a satisfactory seal for the conditions of use, can be selected in practice by simple trial and error. Adhesives or other means could possibly be used to secure the film in place, but heat bonding directly to the gel material is preferred, using for example hot air or flame guns, as known per se, or heated rollers. The film may alternatively be placed in the mould used to form the body of gel, which is thus moulded and bonded to the film in one operation. The bonded film may if desired be arranged or trimmed so that it does not extend beyond the edges of the gel, it being preferred that substantially all of the sealing surface of the gel is covered by the film.

The sealing device may be used in an in-line splice closure, in which the housing has a seal adjacent each end thereof, but is especially useful in a butt splice closure, in which the housing has a seal adjacent one end thereof and is blind at an opposite end thereof. The housing may be of unitary construction, or may comprise a base and a cover therefore, the base receiving the sealing device. The cover or unitary housing is preferably substantially dome shaped. The two-part construction may be held together by a circular or other clamp, optionally together with an O-ring or other sealing means positioned between two abutting surfaces of the two parts.

Although the sealing device will be useful for sealing a single cable (or other elongate object), for example as a feedthrough where the cable passes through a wall or bulkhead, in general we prefer that it be used to seal a plurality of cables. In general, the sealing device will be provided with respective axial holes for each cable.

Preferably the gel is sandwiched between relatively rigid compression members which can be brought towards one another to cause axial compression of the gel sealing material. This axial compression results in radial expansion of the gel that seals any gap between the cables and/or between the cables and the housing. The compressing members may be brought together by any convenient means, for example a nut and bolt, one of which preferably bears on an end of a compression spring, and the other of which bears on one of the compression members. In this way the sealing material is maintained under compression by the resilience of the spring, as known per se.

The liquid-in-polymer gel sealant material preferably has a cone penetration (measured by a modified version of ASTM D217) within a range 30-400 (10⁻¹ mm), and/or an ultimate elongation (measured by ASTM D412) greater than 100%, with substantially elastic deformation to an elongation of at least 100%. Generally such materials comprise an oil or other liquid-extended polymer composition. The gel composition preferably contains structures formed from tri-block copolymers having relatively hard blocks and relatively elastomeric blocks, examples of such copolymers including styrene-diene-styrene block copolymers (for example styrene-ethylene/butylene-styrene or styrene-ethylene/propylene-styrene triblock copolymers, including those supplied by Shell under the trademark Kraton, and by Kuraray under the trademark Septon. These block copolymers are extended by oils. The resulting gels will in general be thermoplastic, as is preferred for ease of manufacture of the product. In one embodiment a gel is used comprising 10-14% by weight of the copolymer Kraton G1651, 84-88% of a mineral oil and minor amounts of a stabilizer etc. Other gels can be used if desired, for example those based on polyurethanes or silicones. Harder gels may be made by reducing the oil content, for example by using 78-82% oil and if desired a mixture of block copolymers such as Kraton G1651 and Kraton G1650 preferably about 10% of each. Triblock gels are described in WO-A-9305113 (RK451) and WO-A-9323472 (RK469), and elongate tapes of such gels having an adherent polymer film backing in WO-A-9709391(RK532).

The sealing material is preferably positioned around the cable (or cables) and the housing then slid axially over the sealing device. The sealing device preferably comprises a generally cylindrical plug having an axial hole therethrough for each cable.

The invention is further illustrated by way of example with reference to the accompanying drawings, in which:

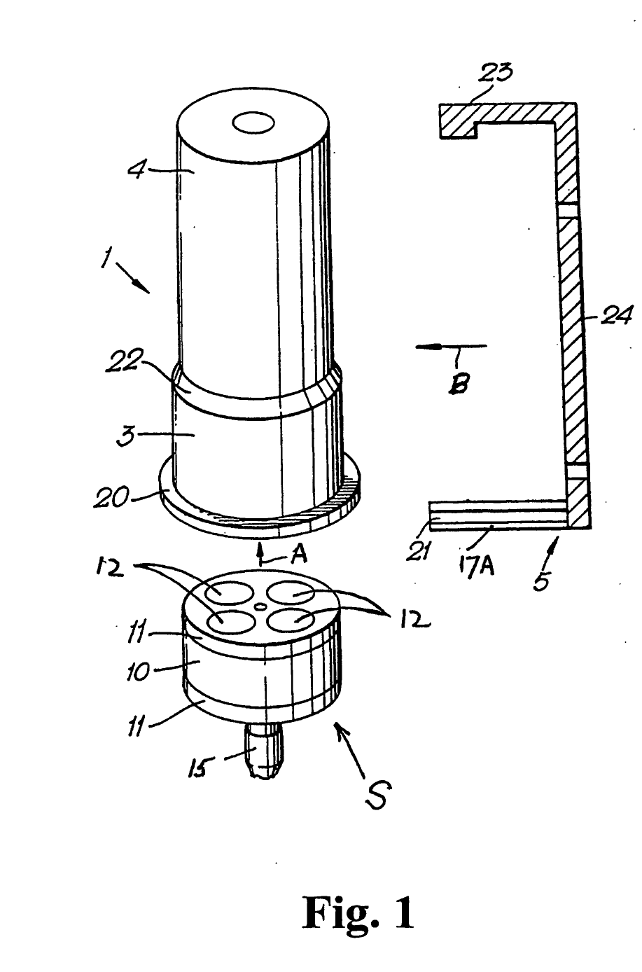

FIG. 1 shows components of a butt splice closure including the sealing device of the present invention;

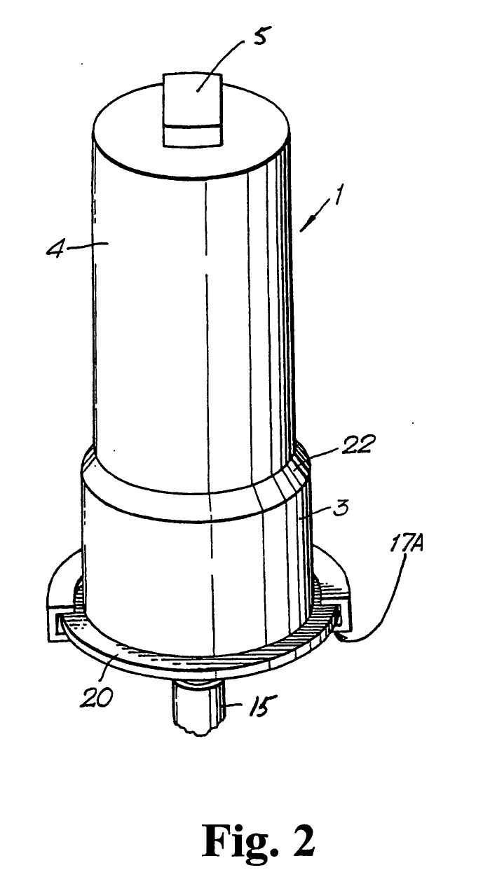

FIG. 2 shows the assembled closure of FIG. 1;

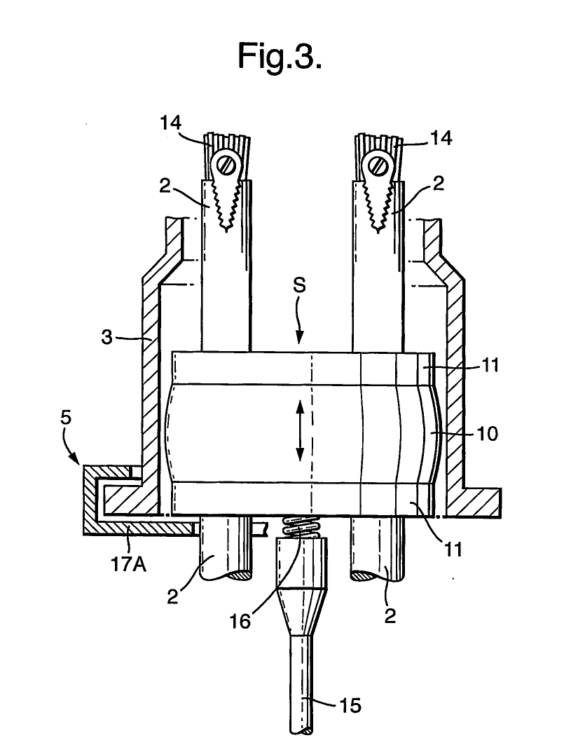

FIG. 3 shows in partial section the sealing device according to the present invention positioned in the assembled closure of FIG. 2; and

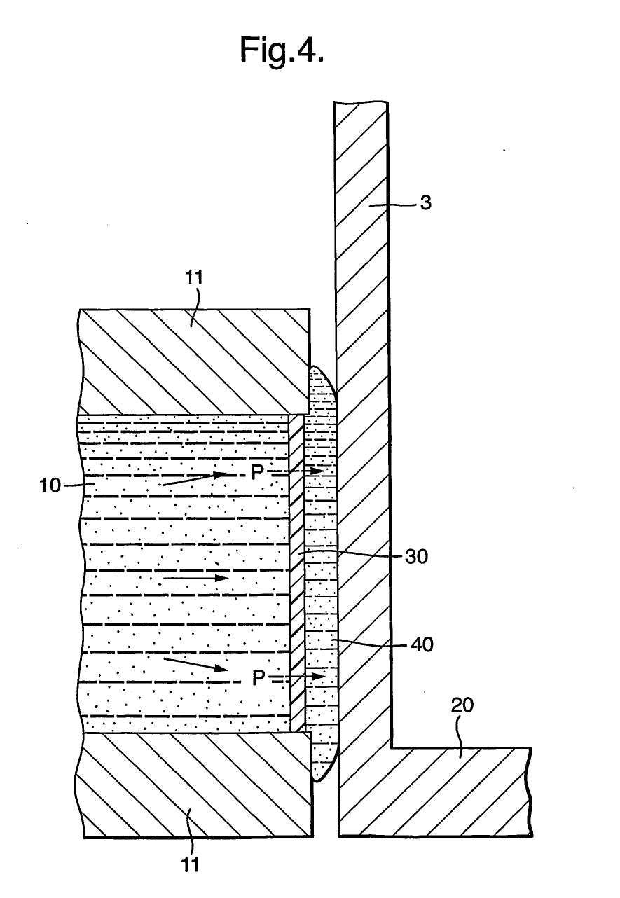

FIG. 4 shows schematically the presence and action of an adherent polymer film on the surface of the gel sealant according to the present invention.

FIGS. 1 and 2 show a butt splice closure 1 for sealing a splice between cables 2 (FIG. 3). The closure 1 comprises a base 3 through which the cables 2 pass and a dome-shaped cover 4 integral with the base 3 and within which the cable splice itself is concealed. The closure includes a sealing device S according to the present invention received within the base 3 and may be held together and/or attached to a pole or other support by means of a bracket 5.

The dome cover 4 and base 3 are shown as integral parts, but they may be separable. The seal S comprising a sealing material 10 between plates 11 is inserted into the open end of the housing, in the direction of the arrow A. Then bracket 5 is slid in the direction of arrow B such that a flange or other means 20 of the housing engages a recess 21 or other means on the bracket 5. A part 17A of the bracket then provides a stop means to retain the seal S. An internal stop means is provided by a shoulder 22 joining the base 3 and cover 4. A top portion 23 of the bracket can snap over or otherwise engage a part of the cover 4 to hold it in place.

Such an external bracket 5 can have the sole function of providing a stop means (particularly the stop means 17A), or it may have one or more other functions. For example it may hold together base 3 and cover 4, and/or it may be used to secure the closure 1 to a wall or pole etc., for example by means of an axial part 24 of the bracket.

FIG. 3 shows two cables 2 passing into the closure through holes 12 (FIG. 1) in the sealing member S and their jackets are removed from the portions within the closure in order to allow their conductors 14 to be connected together. Four cable holes 12 are illustrated in FIG. 1, the number of holes being chosen according to the number of cables to be accommodated, which is two in FIG. 3. The member S may be laterally openable in manner known per se, but not shown here for simplicity, to receive and close around the cables.

The closure needs to be sealed against the environment to prevent damage by moisture etc. getting in to the conductors 14. This requires sealing of any gap between the cables and the walls of the base, or other part of the overall housing of the closure. In the embodiment illustrated, such a gap is sealed by device S having a sealing gel material 10 located between two plates 11 or other means allowing the sealing material to be compressed longitudinally. Such longitudinal compression (which in FIG. 3 has not yet been effected) causes the sealing material to be displaced radially outwards to form the desired seal. In practice, the gel 10 may rub against the inner surface of the base 3 during insertion of the sealing device S, before the longitudinal compression is applied, leading to problems addressed by the present invention, but a space is shown between the gel and the inner surface for clarity in FIG. 3.

The plates 11 can be brought together to apply the compression by means of a device 15 that is or contains a nut that on rotation moves along a bolt (hidden in the figures) thus forcing spring 16 against the lower (as illustrated) of the two plates 11. The bolt is attached to the upper (as shown) plate 11, and tightening of the nut therefore brings the plates together, causing the desired deformation of the sealing material 10. The sealing device S is retained within the base 3 by the inwardly turned rim or lip 17A of the bracket 5 engaging the lower plate 11, as partly shown in FIG. 3.

FIG. 4 shows schematically the presence of the plastics film 30 on the outer surface of the gel 10 between plates 11 of the sealing device S according to the present invention. The film 30 is permeable to the liquid component of the gel 10 which liquid has migrated through the film in the direction of arrows P, to an extent resulting in a thin layer 40 of the liquid between the film 30 and the inner surface of the closure base 3 against which the film is pressed by the outwards deformation of the gel. It is believed that the resulting layer 40 of the gel liquid helps to easily slide the sealing device in and out of the housing on insertion and removal of the device S, without unacceptably affecting the sealing of the enclosure. However, substantially impermeable plastics films 30, if used, would still decrease the risk of damage to the gel and prevent adhesion of the gel to the base 3 according to the present invention. The gel liquid or other lubricant liquid may be applied directly to the external surface of the film and/or to the interior surface of the base before insertion of the device S into the base 3.

1. A device for sealing an aperture, the device comprising liquid-in-polymer gel material and means for forcing the gel material outwards into compression against an interior surface of the aperture in which the device is to be positioned in use, characterised in that a thin, flexible and preferably stretchable, coherent film of plastics material is positioned on (preferably adhered to) a surface of the gel material intended to seal against the said interior surface, preferably with a liquid component of the gel material in between the film and the interior surface.

2. A device according to claim 1, wherein the said plastics film thickness is within the range from 10 to 50 micrometres, preferably 15 to 40 micrometres, more preferably 20 to 30 micrometres.

3. A device according to claim 1 or 2, wherein the plastics film is permeable to a liquid component of the gel material, thus enabling a portion of the said liquid component to migrate, in use of the device, to the interface between the plastics film and the said interior surface of the aperture.

4. A device according to any preceding claim, wherein the plastics film is polyethylene, preferably linear-low-density polyethylene and/or similar or identical to food wrapping cling film.

5. A device according to any preceding claim, having the gel material sandwiched between relatively rigid members and having means for drawing the rigid members together axially so as to deform the gel laterally outwards.

6. A device according to any preceding claim, having at least one axial through-hole through which a cable or other elongate article can extend.

7. A device according to any preceding claim when positioned in and sealing an aperture in a wall, or in the housing of a cable joint enclosure.

8. A device according to claim 6, when positioned in and sealing an aperture in a wall or in a housing of a cable joint enclosure about one or more cables or other elongate objects extending through the said through-hole(s) in the device.

9. A device according to claim 7 or 8 wherein the aperture it is sealing is an open end of a wrap-around (longitudinally openable) or non-wrap-around (circumferentially continuous) cable joint enclosure, preferably a butt joint domed enclosure, in which the sealing device is axially inserted or removed.

10. A kit-of-parts for enclosing a cable splice, comprising a device according to claim 6 and a housing capable of enclosing parts of one or more cables extending through the said device when the said device is positioned in and seals an aperture of the housing.

11. A method of making a device according to any of claims 1 to 9, comprising applying the said film of plastics material on the surface of the gel material and heating to bond the film to the gel material.

12. A method according to claim 11, wherein the said film is wrapped around the device in contact with the surface of the gel material, and the heating causes some circumferential shrinkage of the film.
